(19) United States
(12) Patent Application Publication
(10) Pub. No.: US 2012/0090385 A1
(43) Pub. Date: Apr. 19, 2012

(54) SYSTEM FOR MONITORING UNDERWATER CHARACTERISTICS

(75) Inventors: Marcin Michel, New Smyrna Beach, FL (US); Jakub Goryszewski, Biale Blota (PL)

(73) Assignee: UTMOST TECH LLC, Port Orange, FL (US)

(21) Appl. No.: 13/274,713

(22) Filed: Oct. 17, 2011

Related U.S. Application Data
(60) Provisional application No. 61/393,765, filed on Oct. 15, 2010.

(51) Int. Cl. G01N 30/62; H04N 7/18; H04B 13/02; G01N 11/00

(52) U.S. Cl. 73/61.61; 73/53.01; 348/81; 340/850; 348/E07.085

(57) ABSTRACT

A system is provided herein by which underwater characteristics may be easily checked for evaluation. The system may be configured to include: a housing; an arrangement for detecting a characteristic of the water disposed in or on the housing; a buoy; an arrangement for transmitting data disposed in the buoy; an anchor for tethering the housing to a bottom of a body of water; an arrangement for transmitting data collected by the detecting arrangement to the arrangement for transmitting data disposed in the buoy; and, a second anchor for tethering the buoy to the housing. Advantageously, with the subject invention, the level of clarity of water, and/or other water characteristics, may be detected and transmitted to a remote location so as to be accessible over a network of computers, such as the Internet.

### CROSS-REFERENCE TO RELATED APPLICATION

This application claims priority to U.S. Provisional Patent Application No. 61/393,765, filed Oct. 15, 2010, the entire contents of which are incorporated by reference herein.

### BACKGROUND OF INVENTION

The pleasure and effectiveness of many water-related activities are dependent on the characteristics of the water, particularly underwater characteristics. Water characteristics for surface water activities, such as boating and sailing, may be readily evaluated by a visual inspection. However, underwater activities, such as fishing, scuba diving and snorkeling, may be affected by underwater conditions, which are not readily subject to evaluation from water surface level. For example, water clarity affects underwater visibility which may directly correlate to a diving or snorkeling experience. Also, water temperature, particularly at various depths, may affect fish movement which impacts the ability to fish.

### SUMMARY OF THE INVENTION

A system is provided herein by which underwater characteristics may be easily checked for evaluation. The system may be configured to include: a housing; an arrangement for detecting a characteristic of the water disposed in or on the housing; a buoy; an arrangement for transmitting data disposed in the buoy; an anchor for tethering the housing to a bottom of a body of water; an arrangement for transmitting data collected by the detecting arrangement to the arrangement for transmitting data disposed in the buoy; and, a second anchor for tethering the buoy to the housing. Advantageously, with the subject invention, the level of clarity of water, and/or other water characteristics, may be detected and transmitted to a remote location so as to be accessible over a network of computers, such as the Internet.

These and other features of the invention will be better understood through a study of the following detailed description and accompanying drawings.

### BRIEF DESCRIPTION OF THE DRAWINGS

FIG. 1 is a schematic of a system formed in accordance with the subject invention;

FIG. 2 is a cross-sectional schematic of a housing useable with the subject invention;

FIGS. 3-5 depict various detector arrangements for detecting water clarity;

FIGS. 6-7 depict a multi-walled housing useable with the subject invention; and,

FIGS. 8-9 depict detector arrangements for detecting speed and direction of a passing water current.

### DETAILED DESCRIPTION OF THE INVENTION

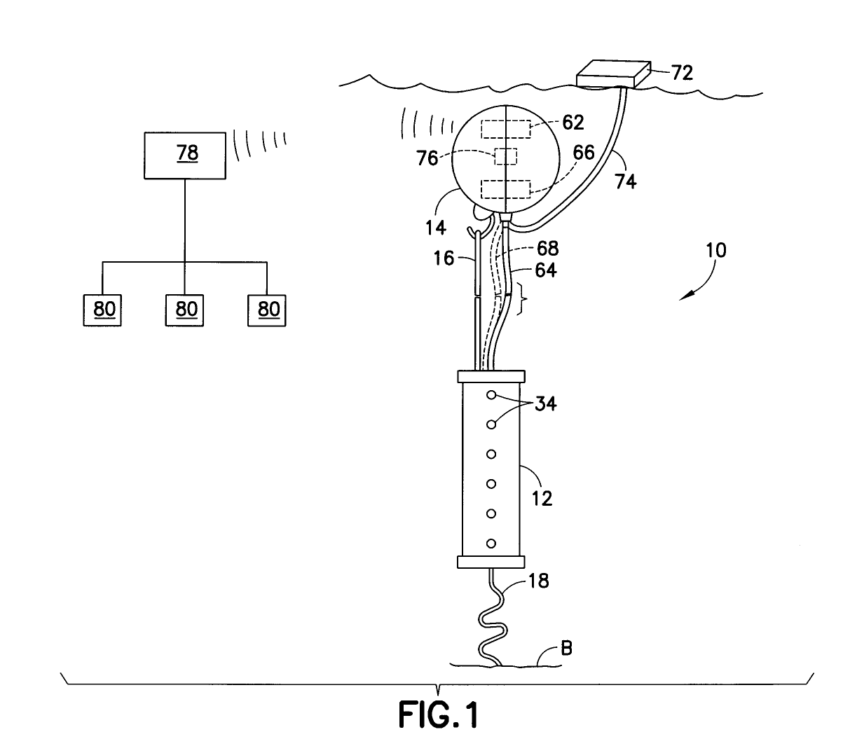

As shown in FIG. 1, a system 10 is provided herein for monitoring one or more water characteristics from an underwater perspective which includes a housing 12 tethered to a buoy 14 via an anchor 16. The housing 12 is submerged in the water and tethered to a bottom B of the body of water via an anchor 18. The system 10 may be utilized in various bodies of water, and is well-suited for deep bodies of water, such as bays and oceans. The system 10 may be located at popular sites for underwater activities, such as dive sites and fishing locations. The housing 12 may be located at depths of up to 1,000 feet (approximately 300 m).

The housing 12 includes one or more enclosed volumes 20 to enclose or support equipment for detecting different water characteristics, such as water clarity. For illustrative purposes, the housing 12 is shown and described as having one enclosed volume; it is to be understood that the housing 12 may include multiple enclosed volumes. The housing 12 is formed of a sufficiently robust material to withstand the pressure of deep water and is corrosion resistant, such as anodized aluminum. Also, the housing 12 may be configured with various shapes and sizes, including being elongated with a rod shape. In a preferred embodiment, the housing 12 includes a tubular body 22 with two end caps 24 sealing the ends of the tubular body 22. Sealing material 26, in the form of a gasket, o-ring, sealant material (e.g., silicone), and so forth, may be disposed between the tubular body 22 and one or both of the end caps 24 to define a seal therebetween. Any form of connection may be used to secure the end caps 24 to the tubular body 22, including fixed connection (e.g., welding) or removable connection (e.g, threaded connection, mechanical fasteners, etc.).

As will be appreciated by those skilled in the art, various detectors may be disposed in or on the housing 12 for monitoring different characteristics of surrounding water. A detector 28 may be provided for detecting the clarity of the water. It is preferred that the detector 28 be located in the housing 12, particularly within the enclosed volume 20, so as to be maximally shielded from external light. The detector 28 may be any known detector for detecting water clarity. By way of non-limiting example, the detector 28 may include any known nephelometer.

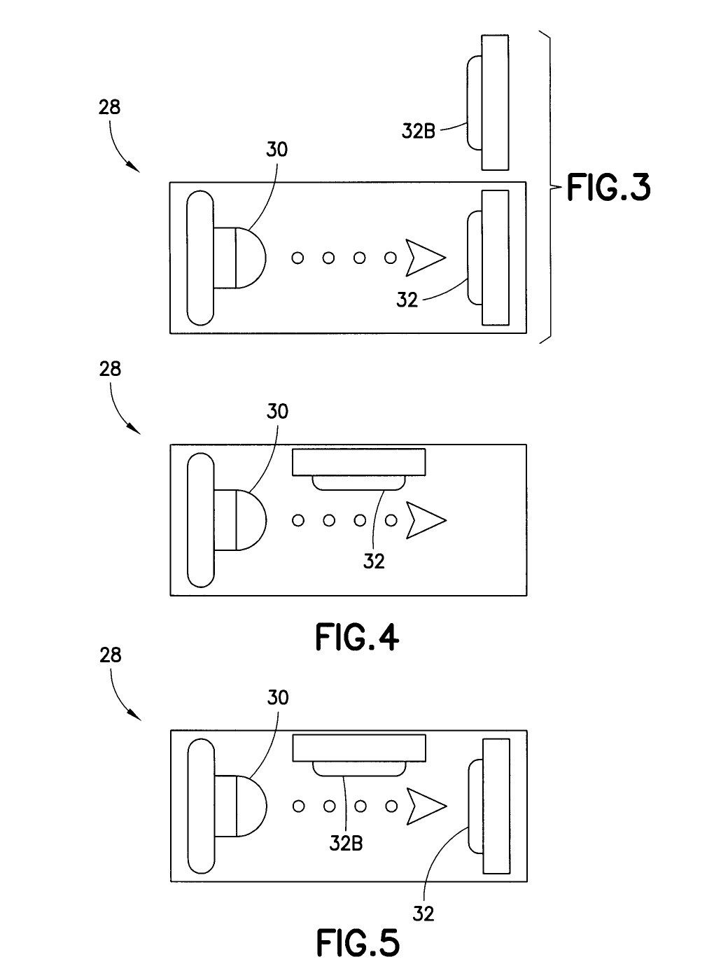

With reference to FIGS. 3 to 5, various arrangements of nephelometers for the detector 28 are shown useable with the subject invention. These are provided as representative examples and do not restrict the invention herein—as indicated above, any known nephelometer for observing water turbidity may be used herewith. With reference to FIG. 3, the detector 28 may include a source of electromagnetic energy 30, which preferably emits light (e.g., one or more light emitting diodes, lasers) but may also emit ultraviolet or infrared signals. The source 30 is disposed to generate energy directly at an electromagnetic energy sensitive element 32 which is sensitive to the energy emitted by the source 30. With the source 30 emitting light, the element 32 may be of various light sensitive elements, including, but not limited to, one or more photodiodes, photovoltaic cells, photo resistors, photo transistors, and/or CMOS array. For detecting turbidity (clarity), water is caused to pass between the source 30 and the element 32 with energy being emitted by the source 30. The amount of energy detected at the element 32 is compared to a standard based on full energy from the source 30 reaching the element 32. Particles in unclear water cause energy to reflect in various directions. The level of water clarity can be determined by comparing the amount of energy detected at the element 32 to the standard. As discussed below, a controller may be used to control the detector 28 and perform the operations noted herein.

The standard for the full energy level may be fixed, e.g. factory set. It is also possible to utilize a second element 32B as a calibrating element. The second element 32B may be used to detect the level of ambient light while the first element 32 is detecting energy from the source 30. The reading detected by the second element 32B may be used as a correction factor for the reading of the first element 32 (i.e., the first element reading may be adjusted in view of the second element reading).

With reference to FIG. 4, the detector 28 may include the source 30 being located to the side of the element 32 such that energy generated by the source 30 passes transversely across the element 32. In this manner, the element 32 detects energy indirectly by detecting energy reflected from particles located in the water. A standard is required for comparison purposes to evaluate clarity based on the detected reflected energy.

With reference to FIG. 5, the configurations of FIGS. 3 and 4 can be combined in that two of the elements 32 are provided to simultaneously detect energy generated by the source 30. The first element 32 is disposed to detect energy directly while the second element 32B is disposed to detect energy indirectly.

Water must pass through the detector 28 for observation. The water may pass through a conduit extending through the housing 12 having a clear observation point at the detector 28 for observation. Preferably, the housing 12 includes apertures 34 which allow flow directly into the enclosed volume 20 for observation.

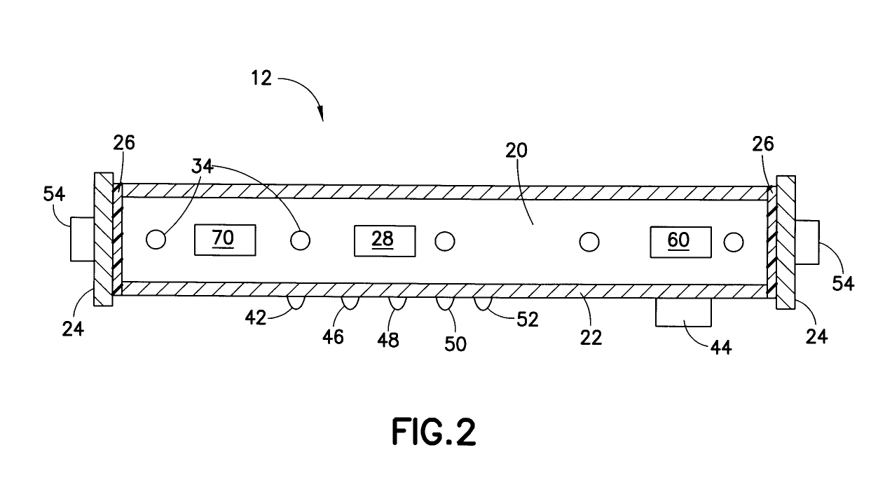

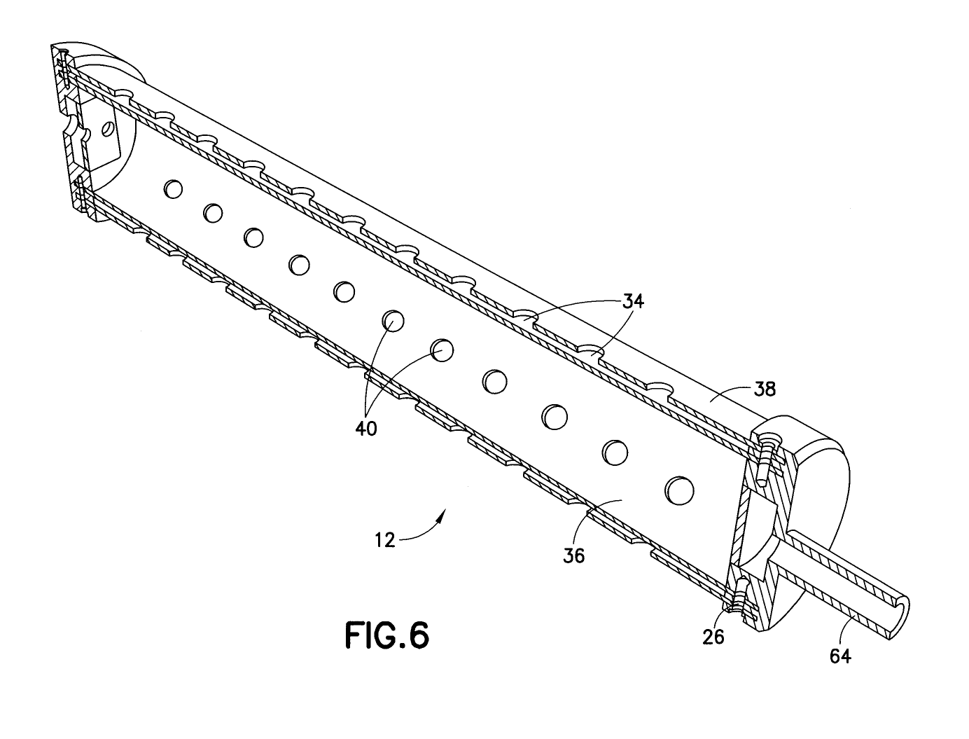

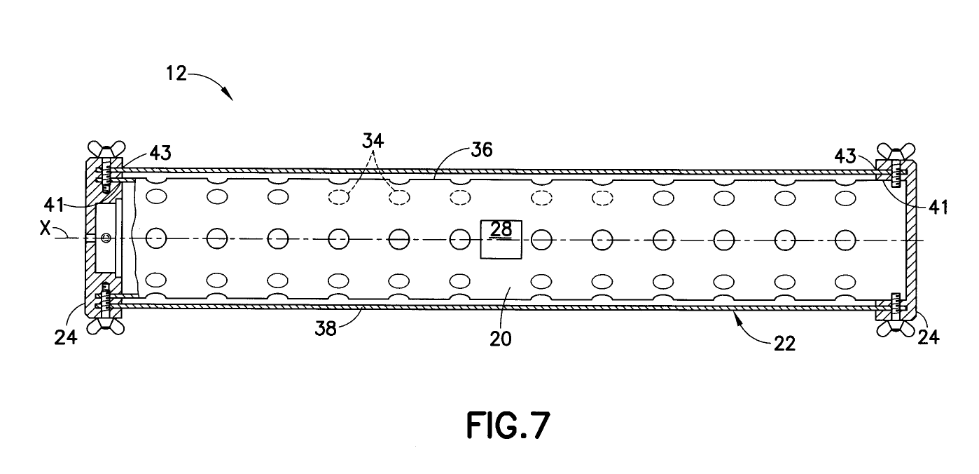

As shown in FIG. 2, the housing 12 may be single walled having the apertures 34 formed therein. With reference to FIGS. 6-7, it is preferred that the housing 12 be multi-walled with at least an inner wall 36 and an outer wall 38 with the outer wall 38 being located in a spaced relationship at least partially about the inner wall 36. It is preferred that the outer wall 38 circumscribe the inner wall 36. In a preferred embodiment, the tubular body 22 is double-walled with it being composed of the inner and outer walls 36, 38. The apertures 34 are formed in the outer wall 38 with inner apertures 40 being formed in the inner wall 36. The inner wall 36 at least partially defines the enclosed volume 20 and encases the detector 28 therein. It is preferred that the apertures 34 and the inner apertures 40 be arranged out of alignment, e.g., as shown in FIG. 7. The apertures 34 and the inner apertures 40 may be positioned to be circumferentially and/or axially out of alignment relative to a central longitudinal axis X of the housing 12. In this manner, the apertures 34 and the inner apertures 40 are out of alignment (no overlap) as viewed along reference axes disposed perpendicularly to the axis X. In this manner, water may pass through the inner and outer walls 36, 38 into the enclosed volume 20 with minimal to no light infiltrating the enclosed volume 20. Water clarity can be, thus, observed by the detector 28 within the enclosed volume 20 with little to no external light interference.

In a preferred embodiment, the end caps 24 are provided with inner and outer channels 41, 43 in which the inner and outer walls 36, 38 are seated respectively. The sealing material 26 may be disposed in the channels 41, 43 to form seals thereat.

Other water characteristics may be evaluated by the system 10. For example, water temperature may be observed through one or more temperature sensing devices 42 located in or on the housing 12. Further, a camera 44, such as a digital camera, may be located in or on the housing 12 to obtain still or moving images observed from the housing 12. With the camera 44 inside the housing 12, a window may be formed through the housing 12 to provide the camera 44 with visual access of the surrounding environment. It is preferred to have the camera 44 located outside the housing 12 to minimize light infiltration into the housing 12.

Chemical characteristics of the water may be also monitored by including on or in the housing 12, one or more of the following detectors: a pH detector 46; oxygen detector 48; carbon dioxide detector 50; and/or, a salinity detector 52. As will be appreciated by those skilled in the art, other elements, gases and characteristics may be monitored. The monitoring of one or more of these characteristics may be useful for scientific purposes.

The system 10 may be also configured to monitor the speed and direction of water currents passing by the housing 12. Any known configuration for detecting the speed and/or direction of water current may be utilized. For example, a rotatable paddle wheel with the rudder may be mounted to the housing 12 for detecting the speed of a passing current (meter based on potentiometer and encoder). By way of non-limiting example, and with reference to FIG. 2, one or more speed detectors 54 may be provided on the housing 12 for detecting the speed of a passing current. To increase omnidirectionality for monitoring purposes, it is preferred that a plurality of the speed detectors 54 be utilized spaced about the housing 12 (preferably, two speed detectors 54 are used located at both ends of the housing 12).

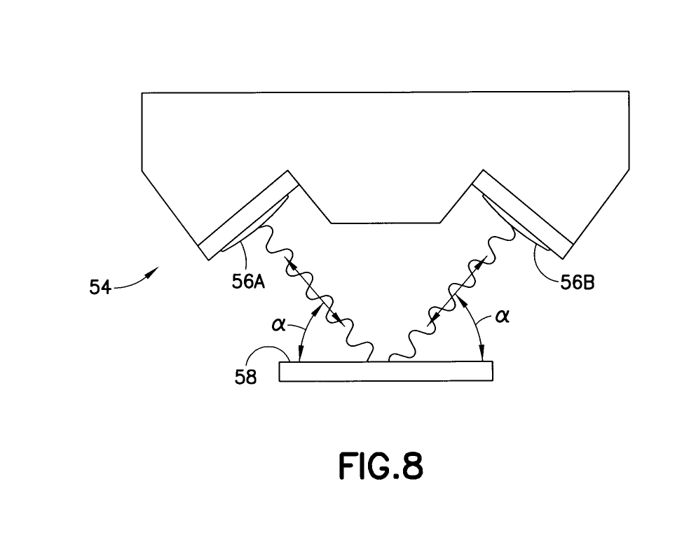

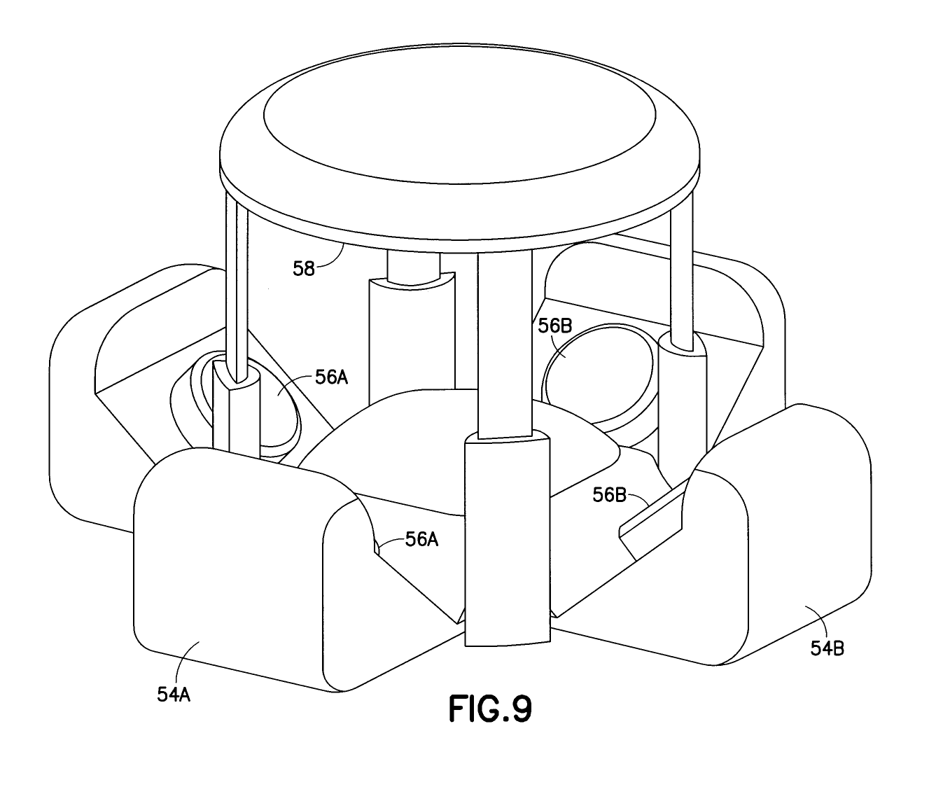

With reference to FIG. 8, the speed detector 54 includes two ultrasound emitters 56A, 56B and a reflecting plate 58. The ultrasound emitters 56A, 56B are configured and located to transmit and receive ultrasound signals therebetween which are reflected by the reflecting plate 58. Preferably, both of the ultrasound emitters 56A, 56B are disposed to transmit signals having an angle of incidence a of approximately 45 degrees relative to the reflecting plate 58. In operation, a first of the ultrasound emitters 56A transmits an ultrasound signal through water with the signal being reflected by the reflecting plate 58 and received by the second of the ultrasound emitters 56B. Due to the Doppler effect, the difference in wave frequency between the signal transmitted by the first ultrasound emitter 56A and the signal received by the second ultrasound emitter 56B is a direct function of the speed of the passing water. As such, the time of signal travel between transmission and receipt can be used to calculate the water's speed.

It has been determined that large errors may occur in calculating current speed since the actual measurement is based on an extremely small time frame, which may be on the order of milliseconds. To increase the accuracy of the speed calculation, it is preferred that two readings be taken: a first time interval reading based on a signal transmitted by the first ultrasound emitter 56A and received by the second ultrasound emitter 56B; and a second time interval reading based on a signal transmitted by the second ultrasound emitter 56B and received by the first ultrasound emitter 56A. It will be noted that one reading will be greater than the other in that the signal transmitted in the direction of the current of the passing water will travel faster between the ultrasound emitters 56A, 56B than the signal transmitted against the current. Using this information, the speed of the passing water may be calculated as follows:

v=[(t₂−t₁)/(t₁×t₂)]×[L/(2×cos(a))] (Eq. 1)

where,
v—water current speed
t₁—ultrasonic wave travel time in the direction travelling with current
t₂—ultrasonic wave travel time in the direction against the current
L—distance between the ultrasound emitters, and
a—angle between the ultrasonic waves and the water current (can be taken as equal to the angle of incidence α).

A pair of the speed detectors 54 (54A, 54B) may be used to calculate a speed and direction of the water current. With reference to FIG. 9, the speed detectors 54A, 54B may be arranged substantially orthogonally to each other. A common reflecting plate 58 may be provided for both of the speed detectors 54A, 54B. Once both speed detectors 54A, 54B have determined velocity calculations at a particular instance, the two determined velocities are taken as two velocity components. With the speed detectors 54A, 54B being disposed at a 90 degree separation, the two velocity components can be taken as Cartesian x and y components with a resultant velocity being resolved representing the speed and direction of the water current. It is preferred that a pair of the speed detectors 54A, 54B be provided at each end of the housing 12 in this configuration.

A controller 60, which may include one or more CPU's or microprocessors, may be provided with the housing 12 to control the various detectors and provide calculations as necessary. The controller 60 may be also configured to process data collected by one or more of the detectors for transmitting to the buoy 14 as described below.

A transmitter 62 for transmitting data collected at the housing 12 is located in the buoy 14. The transmitter 62 may be any known type for wirelessly transmitting the data, including, but not limited to, a satellite, radio, and/or GSM (or equivalent) transmitter. The buoy 14 is formed water-tight to contain the transmitter 62 and other equipment. Data collected by any detector located in the housing 12 is transmitted to the buoy 14 for subsequent transmission by the transmitter 62. The data may be transmitted wirelessly from the housing 12 to the buoy 14 (e.g., with a wireless transmitter (e.g., provided with the controller 60)), or, preferably, through a hard wire connection, such as through a signal cable 64. Water-tight connections for the signal cable 64 are preferably utilized. Even if the signal cable 64 is provided, it is preferred that the anchor 16 be provided to tether the buoy 14 to the housing 12, so as to minimize stress imparted on the signal cable 64. It is possible to have the signal cable 64 also perform the anchor function with no separate anchor 16.

The buoy 14 is preferably located at or near water surface to provide minimum interference from surrounding water to the signal transmitted by the transmitter 62. In this manner, a relatively strong signal representing data collected underwater at the housing 12 may be sent from the buoy 14.

It is preferred that the system 10 be powered by a battery pack 66 located in the buoy 14. Power required in the housing 12 may be transmitted from the buoy 14 through a cable coupled with the battery pack 66, including possibly through the signal cable 64. An auxiliary cable 68 may be also used to transmit power from the buoy 14 to the housing 12. It is possible to provide a battery pack 70 to the housing 12 which would obviate the need to transmit power from the buoy 14 to the housing 12. However, due to the underwater location of the housing 12, maintenance of such a battery pack 70 may be difficult. With the buoy 14 being located at or near water surface, maintenance of the battery pack 66 may be easier by being located in the buoy 14. The battery pack 66 may be replaceable, e.g., as single use. Alternatively, solar panels or other means for recharging electrical power 72 (such as equipment for transforming ocean wave motion into electrical energy) may be utilized for recharging the battery pack 66, such as via cable 74. A controller 76, which may be one or more CPU's or microprocessors, may be provided with the buoy 14 for receiving data from the housing 12 and preparing the data for transmission by the transmitter 62. The controller 76 may be also coupled to the battery pack 66 for distributing power to the housing 12 and the transmitter 62. The controller 76 may be also configured to control the detectors in the housing 12 and provide calculations as necessary. In this manner, the controller 60 at the housing 12 may not be necessary. The controller 76 may be coupled with the detectors via the signal cable 64.

Data collected within the housing 12 and transmitted by the transmitter 62 in the buoy 14 may be received by a receiver 78 which is remotely located. Any configuration of transmitter 62 and receiver 78 may be utilized. The receiver 78 may be coupled to a network of computing devices 80, which may be a local area network, a wide area network or a global network, such as the Internet. Users of the network may access the collected data to evaluate underwater characteristics at the site of the housing 12.

By having systems 10 located at desirable sites for certain underwater activities, potential users may readily evaluate real-time characteristics in deciding whether to participate in a particular activity. For example, poor clarity conditions may discourage certain individuals from participating in a dive at a particular dive site. Conversely, good clarity conditions may encourage certain users to participate in a dive at that dive site. Likewise, individuals contemplating fishing at particular locations may evaluate temperatures in deciding whether to engage in fishing. Real-time images may also provide visual indication of conditions. For example, some individuals may prefer to not dive in areas congested with other divers.

The system 10 described herein may be used simultaneously at various locations to define a network.

What is claimed is:

1. A system for monitoring underwater characteristics, said system comprising:
a housing;
means for detecting one or more characteristics of water disposed in or on said housing;
a buoy;
means for transmitting data disposed in said buoy;
an anchor for tethering said housing to a bottom of a body of water;
means for transmitting data collected by said means for detecting to said means for transmitting data disposed in said buoy; and,
a second anchor for tethering said buoy to said housing.

2. A system as in claim 1, wherein said means for detecting one or more characteristics of water includes means for detecting clarity of water.

3. A system as in claim 1, wherein said means for detecting one or more characteristics of water includes means for detecting temperature.

4. A system as in claim 1, further comprising a camera disposed in said housing.

5. A system as in claim 4, wherein said camera is a digital camera.

6. A system as in claim 5, further comprising means for transmitting data relating to images generated by said camera to said means for transmitting data disposed in said buoy.

7. A system as in claim 1, further comprising receiver means for receiving data transmitted by said means for transmitting data.

8. A system as in claim 7, wherein said receiver means is coupled to a network of computing devices, said data received by said receiver means being accessible by users via said network.

9. A system as in claim 2, wherein said means for detecting clarity of water includes a nephelometer.

10. A system as in claim 1, wherein said means for detecting one or more characteristics of water includes means for detecting levels of certain compounds.

11. A system as in claim 1, wherein said means for detecting one or more characteristics of water includes means for determining speed of water.

12. A system as in claim 1, wherein said means for detecting one or more characteristics of water includes means for determining direction of water current.

13. A system as in claim 2, wherein said housing includes an inner wall at least partially encasing an interior volume disposed along a longitudinal axis and an outer wall located, in a spaced relationship, at least partially about said inner wall, said outer wall having at least one aperture formed therethrough, said inner wall having at least one inner aperture formed therethrough, said inner and outer apertures being out of alignment as viewed along an axis perpendicular to said longitudinal axis, and, wherein, said means for detecting clarity of water being disposed in said interior volume.

14. A system as in claim 1, wherein said means for detecting one or more characteristics of water includes one or more detectors from the group consisting of pH detector, oxygen detector, carbon monoxide detector, and salinity detector.

15. A system as in claim 1, wherein said means for transmitting data collected by said detecting means includes a signal cable.
